(19) United States
(12) Patent Application Publication
(10) Pub. No.: US 2020/0391537 A1
(43) Pub. Date: Dec. 17, 2020

(54) BINDER WITH INTEGRATED DISPLAY DEVICE

(71) Applicant: Chiu Wai CHUI, Hong Kong (HK)

(72) Inventor: Chiu Wai CHUI, Hong Kong (HK)

(21) Appl. No.: 16/811,563

(22) Filed: Mar. 6, 2020

Related U.S. Application Data
(60) Provisional application No. 62/860,379, filed on Jun. 12, 2019.

(30) Foreign Application Priority Data
Jan. 13, 2020 (CN) 202020067227.9

(51) Int. Cl. B42F 13/40; G06K 19/077; B42F 13/16; B42F 13/00

(52) U.S. Cl. CPC B42F 13/40; B42F 13/0026; B42F 13/16; G06K 19/07707

(57) ABSTRACT

The present application relates to the field of binders, and provides a binder with an integrated display device, including: a front cover, a back cover, a spine connecting the front cover and the back cover, a control circuit located inside the binder, and an integrated display device located in at least a part of the binder, where the integrated display device includes a control switch connected to the control circuit, and one or more display elements embedded in the binder, the one or more display elements are connected to the control circuit and arranged in a specific design, and the binder is configured such that, after the control switch is triggered, the one or more display elements of the integrated display device present an audiovisual effect including at least one of LED lighting, LED flashing, graphic display, and sound.

### CROSS-REFERENCE TO RELATED APPLICATIONS

This application claims priority to U.S. Provisional Application No. 62/860,379, filed on Jun. 12, 2019, and Chinese Utility Model Application No. 202020067227.9, filed on Jan. 13, 2020, the contents each of which are incorporated herein by reference in their entirety.

### TECHNICAL FIELD

The present application relates to the field of binder products, and more specifically relates to a binder with an integrated display device.

### BACKGROUND

Traditional binder or folder products are used to organize and store files or folders, and are also widely used in the covers of notebooks for protection and aesthetic performance. However, such a binder or folder product is unitary and lacks a communication and interaction system, users are prone to aesthetic fatigue, and the user experience is poor.

Further, conventional binders may lack a communication system for sharing their local usage and performance statistics with other electronic devices in a space such as an office, or for sharing remote usage and performance statistics with electronic devices in a space such as a hotel chain, global offices, or in other locations in differing regions, locations, states or countries. Further, the conventional binders may lack system to authenticate users before letting a user to access, for e.g., a confidential document that may be stored in the binder.

Therefore, there is a need to provide an improved binder with an integrated display device to overcome one or more of the problems and/or limitations described above.

### SUMMARY

An objective of the present application is to provide a binder with an integrated display device, which aims to solve the technical problems that the traditional binder products lack integrated display devices, and thus lack interaction and interest.

The present application is realized in this way, and provides a binder with an integrated display device, including: a front cover, a back cover, a spine connecting the front cover and the back cover, a control circuit located inside the binder, and an integrated display device located in at least a part of the binder, where the integrated display device includes a control switch connected to the control circuit, and one or more display elements embedded in the binder, the one or more display elements are connected to the control circuit and arranged in a specific design, and the binder is configured such that, after the control switch is triggered, the one or more display elements of the integrated display device present an audiovisual effect including at least one of LED lighting, LED flashing, graphic display, and sound.

In an embodiment of the present application, at least one of the front cover, the back cover and the spine is hollow thin-layer box, the control circuit is fixed in the box, at least one surface of the box defines openings, and shapes of the openings match shapes of the one or more display elements and the control switch.

In an embodiment of the present application, the one or more display elements include light-emitting elements on the back or inside thereof.

In an embodiment of the present application, each of the one or more display elements is a transparent or translucent colored plastic film, and the transparent or translucent colored plastic film is embedded in the opening of the box corresponding to the specific design and flush with a surface of the box.

In an embodiment of the present application, each of the one or more display elements is a colored plastic or silicone body, the colored plastic or silicone body is embedded in the box and protrudes from each of the openings of the box corresponding to the specific design.

In an embodiment of the present application, the colored plastic or silicone body is made of an elastic material and configured to deform under external pressure and automatically return to its original shape after the external force is eliminated.

In an embodiment of the present application, the specific design includes a first display unit and a second display unit, the first display unit and the second display unit are integrated display elements or a combination of multiple discrete display elements, the first display unit has a first shape, the second display unit has a second shape, and the light-emitting elements are uniformly distributed along the first shape and the second shape.

In an embodiment of the present application, the light-emitting elements arranged at a corresponding position of the first display unit are connected in series with each other, and the light-emitting elements arranged at a corresponding position of the second display unit are connected in series with each other.

In an embodiment of the present application, one side of the front cover and one side of the back cover have a plurality of through holes, the spine includes a plurality of buckles, the plurality of buckles pass through the plurality of through holes to connect the front cover and the back cover, and paper with corresponding holes can be restricted in the binder through the plurality of buckles.

In an embodiment of the present application, both sides of the spine are connected to one side of the front cover and one side of the back cover, respectively, a binding mechanism is disposed at an inner surface of the spine or an inner surface of the back cover.

In an embodiment of the present application, the spine is made of a cloth material, one end of the spine is integrally connected to the back cover along the circumferential direction of the back cover, the other end is connected to the front cover through a connecting mechanism, and the connecting mechanism includes at least one of a zipper, a Velcro, a lock, and a magnetic button.

In an embodiment of the present application, the control switch is hidden under a surface covering, and the surface covering can be a flat icon or a protrusion.

In an embodiment of the present application, the integrated display device includes at least one of an LED, a screen, a speaker, and a lighting panel.

In an embodiment of the present application, the integrated display device is configured to output one or more variables to a user in at least one of a visual form, an audio form, and an audiovisual form.

In an embodiment of the present application, the binder can include a locking mechanism.

The binder with the integrated display device provided by the present application can realize the interaction between the user and the binder, and provides illumination and display while increasing entertainment and interest, thereby greatly improving the user experience.

### BRIEF DESCRIPTION OF THE DRAWINGS

In order to explain the technical solution in the embodiments of the present application more clearly, the drawings used in the embodiments will be briefly introduced below. It is not difficult to understand that the drawings described in the following specification are just some embodiments of the present application. For those of ordinary skill in the art, other embodiments may be obtained based on these drawings without paying creative labor.

The accompanying drawings, which are incorporated in and constitute a part of the present application, illustrate various embodiments of the present application. The drawings contain representations of various trademarks and copyrights owned by the applicant. In addition, the drawings may contain other marks owned by third parties and are being used for illustrative purposes only. All rights to the various trademarks and copyrights represented herein, with the exception of those belonging to their respective owners, belong to the applicant. The applicant retains all rights in the trademarks and copyrights included herein, and grants permission to reproduce the material only in connection with reproduction of the granted patent and for no other purpose.

FIG. 1 is a schematic view of a front perspective view of a binder with an integrated display device, in accordance with some embodiments of the present application.

FIG. 2 is a schematic view of a front view of a front cover of the binder with an integrated display device, in accordance with some embodiments of the present application.

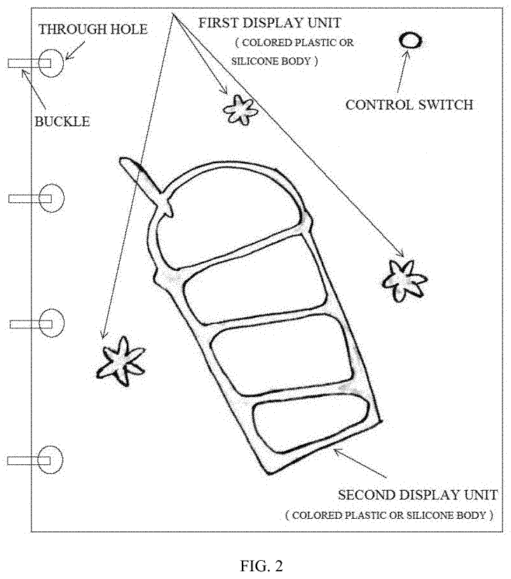

FIG. 3 is a schematic perspective view showing an opened state of the binder with an integrated display device, in accordance with some embodiments of the present application.

FIG. 4 is an illustration of an online platform consistent with various embodiments of the present application.

FIG. 5 is a block diagram of a computing device for implementing the methods disclosed herein, in accordance with some embodiments.

### DETAILED DESCRIPTION

In order to make objectives, technical solutions and advantages of the present application clearer, the present application will be further described in detail below with reference to the accompanying drawings and embodiments. It should be understood that the specific embodiments described herein are only used to explain the present application and are not intended to limit the present application.

It should be noted that various elements as referred to herein (i.e., an element, or elements) may present singular or plural, unless the context clearly indicates otherwise. The term “or” means at least one item in the list, and does not exclude the case of multiple items in the list. The term “and” means all items in the list. The term “comprising” means including one or more of the listed items, and it may also mean including other items that are not listed.

In addition, it should be noted that when an element is referred to as “fixed to/in”, “disposed in/on/a” or “arranged in/on/at” another element, it may be directly or indirectly located on/in the other element. When an element is referred to as being “connected to” another element, it can be directly or indirectly connected to the other element. The orientation or position indicated by terms, such as “up”, “down”, “left”, “right”, “front”, “rear”, “vertical”, “horizontal”, “top”, “bottom”, “inner”, “outer”, or the like, is based on the orientation or position shown in the drawings, is only for convenience of description and cannot be understood as a limitation to the technical solution. The terms “first” and “second” are only used for convenience of description, and cannot be understood as indicating or implying relative importance or implicitly indicating the number of technical features. The meaning of “a/the plurality of” is two or more, unless specifically defined otherwise.

Furthermore, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present application. Accordingly, it is intended that the scope of patent protection is to be defined by the issued claim(s) rather than the description set forth herein.

The present application includes many aspects and features. Moreover, while many aspects and features relate to, and are described in the context of binder with integrated presentation device, embodiments of the present application are not limited to use only in this context.

In order to explain the technical solutions of the present application, detailed description is given below with reference to the drawings and specific embodiments.

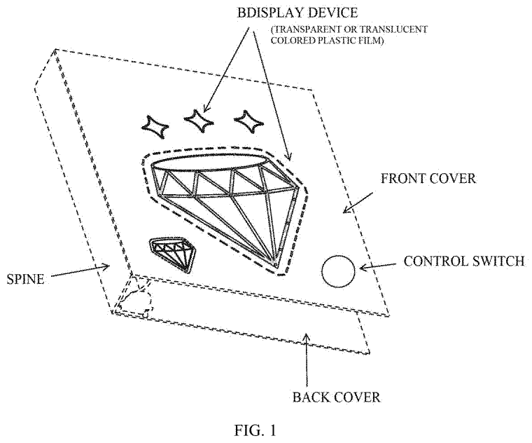

Referring to FIG. 1, FIG. 1 is a front perspective view of a binder with an integrated display device, in accordance with some embodiments of the present application. Where, the binder may be a folder with an integrated display device, which allows the user to store and/or present documents such as files and/or perforated paper in different ways, For instance, but not limited to illuminate the cover with different designs, and/or provide backlighting for film and/or plastic or silicone body.

A binder with an integrated display device according to an embodiment of the present application, including: a front cover, a back cover, a spine connecting the front cover and the back cover, a control circuit located inside the binder, and an integrated display device located in at least a part of the binder, where the integrated display device includes a control switch connected to the control circuit, and one or more display elements embedded in the binder, the one or more display elements are connected to the control circuit and arranged in a specific design, and the binder is configured such that, after the control switch is triggered, the one or more display elements of the integrated display device present an audiovisual effect including LED lighting, LED flashing, graphic display, sound, and/or the like. In some embodiments, the front cover, the back cover, and/or the spine are hollow thin-layer boxes, the control circuit is fixed in the box, at least one surface of the box defines openings, and shapes of the openings match shapes of the one or more display elements and the control switch.

In some embodiments, the integrated display device may be configured to be a system that is configured to facilitate presentation of documents to users in different ways and/or a system that is configured to enhance the aesthetic of the binder. In some embodiments, the specific design may be various patterns or designs, such as a heart shape, a triangle, a polygon, a star, a flower shape, a cup shape, a gem shape, a crown shape, a cartoon character, a landscape map, and combinations thereof. The integrated display device arranged in a specific design can realize illumination and audiovisual effect, and improve aesthetic and interest.

In some embodiments, the one or more display elements include light-emitting elements on the back or inside thereof. In some embodiments, each of the one or more display elements is a transparent or translucent colored plastic film, and the transparent or translucent colored plastic film is embedded in the opening of the box corresponding to the specific design and flush with a surface of the box. In some embodiments, each of the one or more display elements is a colored plastic or silicone body, the colored plastic or silicone body is embedded in the box and protrudes from each of the openings of the box corresponding to the specific design. In some embodiments, the colored plastic or silicone body is made of an elastic material and configured to deform under external pressure and automatically return to its original shape after the external force is eliminated. The use of the elastic material further improves the user experience, thereby achieving the effect of decompression and happy mood.

In some embodiments, the specific design includes a first display unit and a second display unit, the first display unit and the second display unit are integrated display elements or a combination of multiple discrete display elements, the first display unit has a first shape, the second display unit has a second shape, and the light-emitting elements are uniformly distributed along the first shape and the second shape. The first shape and the second shape may be various shapes such as a heart shape, a triangle, a polygon, a star, a flower shape, a cup shape, a gem shape, a crown shape, a cartoon character, a landscape map, the like, and combinations thereof. The combination and match of the first shape and the second shape further improves the aesthetic and display effect of the binder.

In some embodiments, the light-emitting elements arranged at a corresponding position of the first display unit are connected in series with each other, and the light-emitting elements arranged at a corresponding position of the second display unit are connected in series with each other. In some embodiments, the light-emitting elements arranged at the corresponding position of the first display unit are LEDs of the same color, such as blue LEDs, and the light-emitting elements arranged at the corresponding position of the second display unit are LEDs of the same color, such as green LEDs. Different display units with different shapes are illuminated by lamps of different colors, and LEDs of different colors can be controlled by the control circuit to light in order, so as to achieve flashes and animation effects of different colors and shapes.

In some embodiments, one side of the front cover and one side of the back cover have a plurality of through holes, the spine includes a plurality of buckles, the plurality of buckles pass through the plurality of through holes to connect the front cover and the back cover, and paper with corresponding holes can be restricted in the binder through the plurality of buckles. In some embodiments, both sides of the spine are connected to one side of the front cover and one side of the back cover, respectively, a binding mechanism is disposed at an inner surface of the spine or an inner surface of the back cover. Thus, in some embodiments, the binding mechanism may be configured to securely bind the folder and/or perforated paper in one position. In some embodiments, the spine is made of a cloth material, one end of the spine is integrally connected to the back cover along the circumferential direction of the back cover, the other end is connected to the front cover through a connecting mechanism, and the connecting mechanism includes, but is not limited to, a zipper, a Velcro, a lock, and a magnetic button. In some embodiments, the front cover and the rear cover have the same shape, such as rectangular, square, circular, or the like. Different connecting methods make the binder applicable to various products such as a notebook, a folder, a file box, a stationery box, a toolkit, and the like.

Further, in some embodiments, the circuit includes, but is not limited to, one or more display devices, a switch, and/or a power supply. Further, in some embodiments, the one or more display devices may be configured to output one or more variables to a user in at least one of a visual form, an audio form, a tactile form, and/or an audiovisual form. Further, in some embodiments, the one or more display devices may include, but are not limited to, light emitting diodes (LEDs), screens, speakers, tactile displays, lighting panels, and the like.

Further, in some embodiments, at least a portion of the binder (e.g., the outer surface of the front cover) may be covered with a design pattern (a drawing, a print, or an abstract pattern, etc.). For instance, as shown in FIG. 1, the outer surface of the binder includes several drawings of diamonds and stars as a design pattern. Further, in some embodiments, one or more display devices (e.g., LEDs) may be placed together with the design pattern and may be configured to illuminate the design pattern, the design pattern may enhance the aesthetic of the binder.

Further, in some embodiments, when a plurality of binders are placed side by side on a rack, one or more display devices can be disposed in the outer surface of the spine of the binder to uniquely identify each binder. For instance, one binder may include a plurality of red LEDs on the outer surface of the spine, while another binder may include a plurality of blue LEDs.

Further, in some embodiments, the power supply may be configured to provide power to one or more display devices (e.g., LEDs) of the integrated display device. For instance, the power supply may include a battery (For instance, but not limited to, a lithium-ion battery), which may be electrically coupled (through conductive wires) with one or more display devices. Further, in some embodiments, the power supply may be embedded in the front cover of the binder and/or may be covered in a manner that keeps the power supply out of sight. Further, in some embodiments, one or more display devices may be turned on and/or off by using a switch. Further, in some embodiments, a switch may be placed in series between the power supply and one or more display devices to control the power supply. Further, in some embodiments, the switch may be hidden under a surface covering. For instance, as shown in FIG. 1, the switch is hidden under the “Try me” word mark on the front surface. The surface covering may be a flat icon or a protrusion protruding from the surface of the binder.

Further, in some embodiments, the one or more display devices may be turned on and/or off based on a state (such as an open state and/or a closed state) associated with the binder. For instance, when the binder may be in a closed state (e.g. when the front cover and the back cover may be close to each other), then the one or more display devices may remain turned off, whereas when the binder may be in an open state (e.g. when the front cover and the back cover may be apart from each other), then the one or more display devices may be turned on. Further, in some embodiments, the one or more display devices, in an instance, may include lighting panels. Further, the lighting panels, in an instance, may provide backlighting to films, and plastic or silicone bodies for better viewing of such documents. Further, the one or more display devices, in an instance, may be disposed in the inner surface of the at least one of the front cover, the back cover, and the spine of the binder, so as to enhance readability of the documents in poor light situations.

Further, in some embodiments, the one or more display devices may include a refreshable braille display that may be used by a visually impaired user to read content associated with the document of the binder. Further, in some embodiments, the refreshable braille display may be a device configured to display braille characters, usually implemented by means of round-tipped pins raised through holes in a flat surface.

Further, in some embodiments, the one or more presentation devices may include tactile displays that may be configured to provide haptic feedback to a user based on a user's touch.

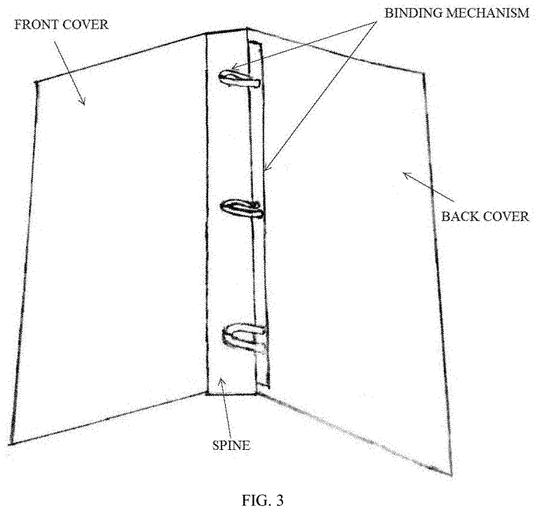

In addition, in some embodiments, the binding mechanism may include a plurality of rings (for e.g. 3 rings as shown in FIG. 3) placed equidistance from each other. Further, in some embodiments, the plurality of rings may be configured to be clipped in a way to facilitate the insertion, storage, and/or removal of folders and/or perforated paper. For instance, each of the plurality of rings may be a two-piece ring, where each piece of the two-piece rings may be pulled apart to facilitate insertion/removal of folders and/or perforated paper. Further, in some embodiments, the binding mechanism may be configured to be locked and/or unlocked based on an actuating signal from an actuator that may be embedded in at least one portion of the binder.

Further, in some embodiments, the binder may include a locking mechanism. Accordingly, the locking mechanism, in an instance, may be configured to securely lock and/or unlock based on an actuating signal received from an actuator that may be embedded in the at least one portion of the binder.

Further, in some embodiments, the binder may include a biometric sensor configured to sense a biometric data associated with the user in order to verify an identity of the user. Further, the biometric data may generally be characterized as a distinct, measurable characteristic that may be embodied in an individual and may be used to label and describe an individual. For instance, the biometric data may include, but not limited to, fingerprint, palm veins, palm print, face recognition, DNA, hand geometry, iris recognition, retina, voice, odor/scent etc.

Further, in some embodiments, the binder may include a memory device configured to store the user data (such as user's biometric data). Further, the binder may include a processing device configured for comparing the biometric data (received from the biometric sensor) with the user data stored in the memory device in order to determine if the user may be an authentic user or not. Further, the processing device, in an instance, may be configured to generate an actuating signal based on the comparing. For instance, if the biometric data sensed by the biometric sensor matches with the user's biometric data stored in the memory device, then the processing device may generate an actuating signal to unlock the binder (by operating the actuator). Further, in another instance, if the biometric data sensed by the biometric sensor may not match with the user's biometric data stored in the memory device, then the processing device may generate an actuating signal to lock the binder (by operating the actuator).

Further, in some embodiments, the biometric sensor may be included in, but not limited to, a smartphone, a laptop/computer, a tablet, a smart watch etc. that may be communicatively coupled with the binder (e.g. through a wireless transceiver).

Further, in some embodiments, the binder may include a wireless transceiver that may allow the binder to communicate with an online platform (such as an online platform 600). Further, a user, in an instance, may operate (such as turn on/off the one or more presentation devices and/or may lock/unlock the binder) the binder by interacting with a user device (such as a mobile device 604, e.g. a smartphone, a laptop, a tablet computer etc., and other electronic devices 606, e.g. desktop computers, server computers etc.) that may be communicatively coupled with the online platform 600. For instance, the mobile device 604, in an instance, may include the biometric sensor that may sense biometric data associated with the user. Further, the biometric data may be received by the binder (through the wireless transceiver) to verify the authenticity of an identity of the user in order to lock/unlock the binder.

In general, the method disclosed herein may be performed by one or more computing devices. For example, in some embodiments, the method may be performed by a server computer in communication with one or more client devices over a communication network such as, for example, the Internet. In some other embodiments, the method may be performed by one or more of at least one server computer, at least one client device, at least one network device, at least one sensor and at least one actuator. Examples of the one or more client devices and/or the server computer may include, a desktop computer, a laptop computer, a tablet computer, a personal digital assistant, a portable electronic device, a wearable computer, a smart phone, an Internet of Things (IoT) device, a smart electrical appliance, a video game console, a rack server, a super-computer, a mainframe computer, mini-computer, micro-computer, a storage server, an application server (e.g. a mail server, a web server, a real-time communication server, an FTP server, a virtual server, a proxy server, a DNS server etc.), a quantum computer, and so on. Further, one or more client devices and/or the server computer may be configured for executing a software application such as, for example, but not limited to, an operating system (e.g. Windows, Mac OS, Unix, Linux, Android, etc.) in order to provide a user interface (e.g. GUI, touch-screen based interface, voice based interface, gesture based interface etc.) for use by the one or more users and/or a network interface for communicating with other devices over a communication network. Accordingly, the server computer may include a processing device configured for performing data processing tasks such as, for example, but not limited to, analyzing, identifying, determining, generating, transforming, calculating, computing, compressing, decompressing, encrypting, decrypting, scrambling, splitting, merging, interpolating, extrapolating, redacting, anonymizing, encoding and decoding. Further, the server computer may include a communication device configured for communicating with one or more external devices. The one or more external devices may include, for example, but are not limited to, a client device, a third party database, public database, a private database and so on. Further, the communication device may be configured for communicating with the one or more external devices over one or more communication channels. Further, the one or more communication channels may include a wireless communication channel and/or a wired communication channel. Accordingly, the communication device may be configured for performing one or more of transmitting and receiving of information in electronic form. Further, the server computer may include a storage device configured for performing data storage and/or data retrieval operations. In general, the storage device may be configured for providing reliable storage of digital information. Accordingly, in some embodiments, the storage device may be based on technologies such as, but not limited to, data compression, data backup, data redundancy, deduplication, error correction, data finger-printing, role based access control, and so on.

Further, one or more steps of the method disclosed herein may be initiated, maintained, controlled and/or terminated based on a control input received from one or more devices operated by one or more users such as, for example, but not limited to, an end user, an admin, a service provider, a service consumer, an agent, a broker and a representative thereof. Further, the user as defined herein may refer to a human, an animal or an artificially intelligent being in any state of existence, unless stated otherwise, elsewhere in the present application. Further, in some embodiments, the one or more users may be required to successfully perform authentication in order for the control input to be effective. In general, a user of the one or more users may perform authentication based on the possession of a secret human readable secret data (e.g. username, password, passphrase, PIN, secret question, secret answer etc.) and/or possession of a machine readable secret data (e.g. encryption key, decryption key, bar codes, etc.) and/or or possession of one or more embodied characteristics unique to the user (e.g. biometric variables such as, but not limited to, fingerprint, palm-print, voice characteristics, behavioral characteristics, facial features, iris pattern, heart rate variability, evoked potentials, brain waves, and so on) and/or possession of a unique device (e.g. a device with a unique physical and/or chemical and/or biological characteristic, a hardware device with a unique serial number, a network device with a unique IP/MAC address, a telephone with a unique phone number, a smartcard with an authentication token stored thereupon, etc.). Accordingly, the one or more steps of the method may include communicating (e.g. transmitting and/or receiving) with one or more sensor devices and/or one or more actuators in order to perform authentication. For example, the one or more steps may include receiving, using the communication device, the secret human readable data from an input device such as, for example, a keyboard, a keypad, a touch-screen, a microphone, a camera and so on. Likewise, the one or more steps may include receiving, using the communication device, the one or more embodied characteristics from one or more biometric sensors.

Further, one or more steps of the method may be automatically initiated, maintained and/or terminated based on one or more predefined conditions. In an instance, the one or more predefined conditions may be based on one or more contextual variables. In general, the one or more contextual variables may represent a condition relevant to the performance of the one or more steps of the method. The one or more contextual variables may include, for example, but are not limited to, location, time, identity of a user associated with a device (e.g. the server computer, a client device etc.) corresponding to the performance of the one or more steps, environmental variables (e.g. temperature, humidity, pressure, wind speed, lighting, sound, etc.) associated with a device corresponding to the performance of the one or more steps, physical state and/or physiological state and/or psychological state of the user, physical state (e.g. motion, direction of motion, orientation, speed, velocity, acceleration, trajectory, etc.) of the device corresponding to the performance of the one or more steps and/or semantic content of data associated with the one or more users. Accordingly, the one or more steps may include communicating with one or more sensors and/or one or more actuators associated with the one or more contextual variables. For example, the one or more sensors may include, but are not limited to, a timing device (e.g. a real-time clock), a location sensor (e.g. a GPS receiver, a GLONASS receiver, an indoor location sensor etc.), a biometric sensor (e.g. a fingerprint sensor), an environmental variable sensor (e.g. temperature sensor, humidity sensor, pressure sensor, etc.) and a device state sensor (e.g. a power sensor, a voltage/current sensor, a switch-state sensor, a usage sensor, etc. associated with the device corresponding to performance of the or more steps).

Further, the one or more steps of the method may be performed one or more number of times. Additionally, the one or more steps may be performed in any order other than as exemplarily disclosed herein, unless explicitly stated otherwise, elsewhere in the present application. Further, two or more steps of the one or more steps may, in some embodiments, be simultaneously performed, at least in part. Further, in some embodiments, there may be one or more time gaps between performance of any two steps of the one or more steps.

Further, in some embodiments, the one or more predefined conditions may be specified by the one or more users. Accordingly, the one or more steps may include receiving, using the communication device, the one or more predefined conditions from one or more and devices operated by the one or more users. Further, the one or more predefined conditions may be stored in the storage device. Alternatively, and/or additionally, in some embodiments, the one or more predefined conditions may be automatically determined, using the processing device, based on historical data corresponding to performance of the one or more steps. For example, the historical data may be collected, using the storage device, from a plurality of instances of performance of the method. Such historical data may include performance actions (e.g. initiating, maintaining, interrupting, terminating, etc.) of the one or more steps and/or the one or more contextual variables associated therewith. Further, machine learning may be performed on the historical data in order to determine the one or more predefined conditions. For instance, machine learning on the historical data may determine a correlation between one or more contextual variables and performance of the one or more steps of the method. Accordingly, the one or more predefined conditions may be generated, using the processing device, based on the correlation.

Further, one or more steps of the method may be performed at one or more spatial locations. For instance, the method may be performed by a plurality of devices interconnected through a communication network. Accordingly, in an example, one or more steps of the method may be performed by a server computer. Similarly, one or more steps of the method may be performed by a client computer. Likewise, one or more steps of the method may be performed by an intermediate entity such as, for example, a proxy server. For instance, one or more steps of the method may be performed in a distributed fashion across the plurality of devices in order to meet one or more objectives. For example, one objective may be to provide load balancing between two or more devices. Another objective may be to restrict a location of one or more of an input data, an output data and any intermediate data therebetween corresponding to one or more steps of the method. For example, in a client-server environment, sensitive data corresponding to a user may not be allowed to be transmitted to the server computer. Accordingly, one or more steps of the method operating on the sensitive data and/or a derivative thereof may be performed at the client device.

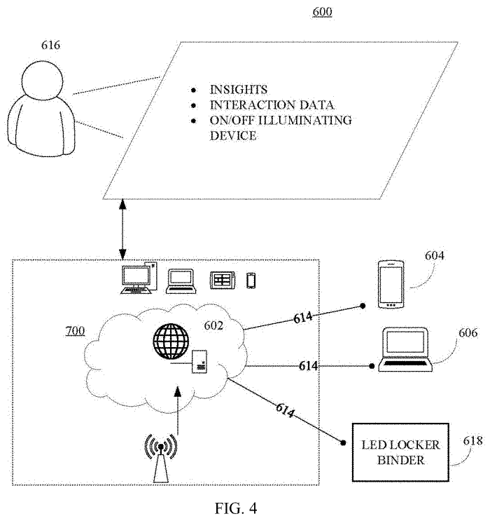

FIG. 4 is an illustration of an online platform 600 consistent with various embodiments of the present application. By way of non-limiting example, the online platform 600 communicatively coupled with the binder with integrated presentation device may be hosted on a centralized server 602, such as, for example, a cloud computing service. The centralized server 602 may communicate with other network entities, such as, for example, a mobile device 604 (such as a smartphone, a laptop, a tablet computer etc.), other electronic devices 606 (such as desktop computers, server computers etc.), and an LED locker binder 618 over a communication network 614, such as, but not limited to, the Internet. Further, users of the online platform 600 may include relevant parties such as, but not limited to, end users, administrators, service providers, service consumers and so on. Accordingly, in some instances, electronic devices operated by the one or more relevant parties may be in communication with the platform.

A user 616, such as the one or more relevant parties, may access online platform 600 through a web based software application or browser. The web based software application may be embodied as, for example, but not be limited to, a website, a web application, a desktop application, and a mobile application compatible with a computing device 700.

Further, in some embodiments, the online platform 600 may allow the binder to communicate with other electronic devices in order to generate insights. Further, the online platform 600, in an instance, may receive an interaction data from the binder.

Further, the binder, in an instance, may be configured to sense the interaction data by using one or more sensor devices. The one or more sensor devices, in an instance, may include, but not limited to, cameras, microphones, temperature sensors, light sensors, pressure sensors, weight sensors etc. that may be embedded within the binder. Further, the binder, in an instance, may be configured to transmit the interaction data (through the wireless transceiver) to the online platform 600. The online platform 600, in an instance, may be configured to process and/or analyze the interaction data to generate the insights. Further, the interaction data, in an instance, may include binder characteristics associated with the binder. The binder characteristics, in an instance, may include, but not limited to, size, weight, height, color, type, material, fabric, components, variables, and/or cost etc. associated with binder. In one embodiment, the binder characteristics may include a location and/or placement of the binder in the local or remote space (such as a locker in a high school). The interaction data, in an instance, may further include a surrounding environment condition, function, use and/or a variation in physical, chemical and/or biological variables associated with the binder. In some embodiments, the interaction data received from the binder, in an instance, may include a used state of the binder. The used state, in an instance, may represent a configuration setting set by the user for the binder. The configuration setting, in an instance, may be parameter settings associated with the locker products, for instance, light intensity settings associated with the one or more presentation device such as the LEDs.

Further, the online platform 600 may analyze the interaction data in order to generate the insights. The insight, in general, may be any information that may convey something of interest with regard to use of the binder. Accordingly, in one embodiment, the insight may include an optimum configuration setting for the binder. The optimum configuration setting, in an instance, may include a light intensity setting of the one or more presentation device (such as the illuminator panel) that may be suitable for a user interacting with the binder. For instance, the light intensity setting of a certain magnitude (say 1000 lux) may be suitable for the user interacting with the illuminator panel of the binder in an office. Further, in another embodiment, the insight, in an instance, may include an expected life range of the binder based on the analysis. The expected life range of the binder, in an instance, may depend on a surrounding environment and/or location of the binder in the space. Further, in some embodiments, the insight, in an instance, may include a usage statistic of the binder. The usage statistic of the binder, in an instance, may signify a frequency with which (and/or when and where) the binder may be used by the user.

Further, the insights, in an instance, may be accessed by a user through the user devices that may be communicatively coupled with the online platform 600.

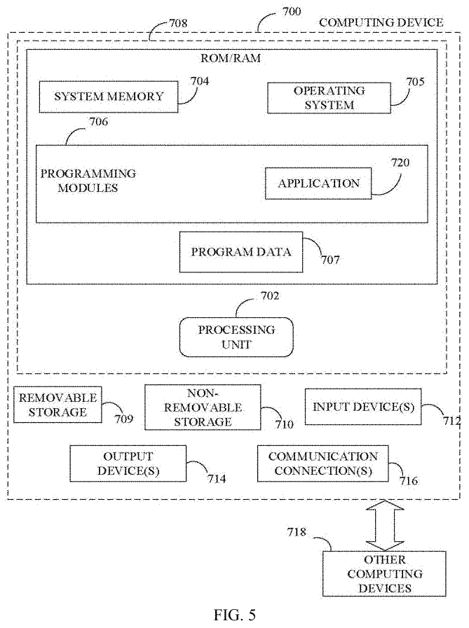

With reference to FIG. 5, a system consistent with an embodiment of the disclosure may include a computing device or cloud service, such as computing device 700. In a basic configuration, computing device 700 may include at least one processing unit 702 and a system memory 704. Depending on the configuration and type of computing device, system memory 704 may include, but is not limited to, volatile (e.g. random-access memory (RAM)), non-volatile (e.g. read-only memory (ROM)), flash memory, or any combination. System memory 704 may include operating system 705, one or more programming modules 706, and may include a program data 707. Operating system 705, for example, may be suitable for controlling computing device 700's operation. In one embodiment, programming modules 706 may include image-processing module, machine learning module. Furthermore, embodiments of the disclosure may be practiced in conjunction with a graphics library, other operating systems, or any other application program and is not limited to any particular application or system. This basic configuration is illustrated in FIG. 5 by those components within a dashed line 708.

Computing device 700 may have additional features or functionality. For example, computing device 700 may also include additional data storage devices (removable and/or non-removable) such as, for example, magnetic disks, optical disks, or tape. Such additional storage is illustrated in FIG. 5 by a removable storage 709 and a non-removable storage 710. Computer storage media may include volatile and non-volatile, removable and non-removable media implemented in any method or technology for storage of information, such as computer-readable instructions, data structures, program modules, or other data. System memory 704, removable storage 709, and non-removable storage 710 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 700. Any such computer storage media may be part of device 700. Computing device 700 may also have input device(s) 712 such as a keyboard, a mouse, a pen, a sound input device, a touch input device, a location sensor, a camera, a biometric sensor, etc. Output device(s) 714 such as a display, speakers, a printer, etc. may also be included. The aforementioned devices are examples and others may be used.

Computing device 700 may also contain a communication connection 716 that may allow device 700 to communicate with other computing devices 718, such as over a network in a distributed computing environment, for example, an intranet or the Internet. Communication connection 716 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 704, including operating system 705. While executing on processing unit 702, programming modules 706 (e.g., application 720 such as a media player) may perform processes including, for example, one or more stages of methods, algorithms, systems, applications, servers, databases as described above. The aforementioned process is an example, and processing unit 702 may perform other processes. Other programming modules that may be used in accordance with embodiments of the present application may include machine learning applications.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, general purpose graphics processor-based systems, multiprocessor systems, microprocessor-based or programmable consumer electronics, application specific integrated circuit-based electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit including discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general-purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present application may be embodied in hardware and/or in software (including firmware, resident software, micro-code, etc.). In other words, embodiments of the present application may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random-access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present application, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present application have been described as being associated with data stored in memory and other storage mediums, data can also be stored on or read from other types of computer-readable media, such as secondary storage devices, like hard disks, solid state storage (e.g., USB drive), or a CD-ROM, a carrier wave from the Internet, or other forms of RAM or ROM. Further, the disclosed methods' stages may be modified in any manner, including by reordering stages and/or inserting or deleting stages, without departing from the disclosure.

The above are only preferred embodiments of the present application, and are not intended to limit the present application. Any modifications, equivalent replacements, and improvements made within the spirit and principles of the present application shall be included in the protection scope of the present application.

1. A binder with an integrated display device, comprising:
a front cover,
a back cover,
a spine connecting the front cover and the back cover,
a control circuit located inside the binder, and
an integrated display device located in at least a part of the binder;
wherein
at least one of the front cover, the back cover and the spine is hollow thin-layer box, the control circuit is fixed in the box, at least one surface of the box defines openings, and shapes of the openings match shapes of the one or more display elements and the control switch;
the integrated display device comprises a control switch connected to the control circuit, and one or more display elements embedded in the binder; the one or more display elements are connected to the control circuit and arranged in a specific design, and the binder is configured such that, after the control switch is triggered, the one or more display elements of the integrated display device present an audiovisual effect including at least one of LED lighting, LED flashing, graphic display, and sound.

2. (canceled)

3. The binder according to claim 1, wherein the one or more display elements comprise light-emitting elements on the back or inside thereof.

4. The binder according to claim 3, wherein each of the one or more display elements is a transparent or translucent colored plastic film, and the transparent or translucent colored plastic film is embedded in the opening of the box corresponding to the specific design and flush with a surface of the box.

5. The binder according to claim 3, wherein each of the one or more display elements is a colored plastic or silicone body, the colored plastic or silicone body is embedded in the box and protrudes from each of the openings of the box corresponding to the specific design.

6. The binder according to claim 5, wherein the colored plastic or silicone body is made of an elastic material and configured to deform under external pressure and automatically return to its original shape after the external force is eliminated.

7. The binder according to claim 3, wherein the specific design comprises a first display unit and a second display unit, the first display unit and the second display unit are integrated display elements or a combination of multiple discrete display elements, the first display unit has a first shape, the second display unit has a second shape, and the light-emitting elements are uniformly distributed along the first shape and the second shape.

8. The binder according to claim 7, wherein the light-emitting elements arranged at a corresponding position of the first display unit are connected in series with each other, and the light-emitting elements arranged at a corresponding position of the second display unit are connected in series with each other.

9. The binder according to claim 1, wherein one side of the front cover and one side of the back cover have a plurality of through holes, the spine comprises a plurality of buckles, the plurality of buckles pass through the plurality of through holes to connect the front cover and the back cover, and paper with corresponding holes is arranged to be restricted in the binder through the plurality of buckles.

10. The binder according to claim 1, wherein both sides of the spine are connected to one side of the front cover and one side of the back cover, respectively, a binding mechanism is disposed at an inner surface of the spine or an inner surface of the back cover.

11. (canceled)

12. The binder according to claim 1, wherein the control switch is hidden under a surface covering, and the surface covering is configured to be a flat icon or a protrusion.

13. The binder according to claim 1, wherein the integrated display device comprises at least one of an LED, a screen, a speaker, and a lighting panel.

14. The binder according to claim 13, wherein the integrated display device is configured to output one or more variables to a user in at least one of a visual form, an audio form, and an audiovisual form.

15. The binder according to claim 1, wherein the binder further comprises a locking mechanism.
